(19) United States
(12) Patent Application Publication
(10) Pub. No.: US 2025/0245526 A1
(43) Pub. Date: Jul. 31, 2025

(54) METHOD FOR GENERATING A PREDICTION SYSTEM FOR A MACHINE

(71) Applicant: Siemens Aktiengesellschaft, München (DE)

(72) Inventors: Robin Feketitsch, Metzingen (DE); Piotr Strauch, Rülzheim (DE)

(73) Assignee: Siemens Aktiengesellschaft, München (DE)

(21) Appl. No.: 18/424,098

(22) Filed: Jan. 26, 2024

(51) Int. Cl. G06N 5/022

(52) U.S. Cl. CPC G06N 5/022

(57) ABSTRACT

A method for generating a prediction system for a machine, the machine being subjected to cyclically variable ambient conditions, the prediction system being configured to predict at least one process variable of the machine. The method comprises a first step, in which a set of training data is provided, the set of training data comprising a plurality of ambient parameters of the machine, a plurality of performance parameters of the machine, and at least one process variable of the machine. Furthermore, the method comprises that a correlation value between the at least one process variable and each of the plurality of ambient parameters and each of the performance parameters of the machine is determined for a first time interval. In a further step, at least one model relevant ambient parameter and at least one model relevant performance parameter are determined based on the corresponding correlation values. Still further, the at least one model relevant ambient parameter, the at least one model relevant performance parameter, and the process variable are being fed into a model generating algorithm and generating a prediction model for the first time interval, the prediction model for the first time interval being a part of the prediction system. In the disclosed method, the model generating algorithm is a Generalized Additive Model (GAM).

### TECHNICAL FIELD

The invention relates to a method for generating a prediction system for a machine and a computer program product that is configured to perform that method. The invention also relates to a self-learning monitoring unit for a machine that is configured to run such a computer program product. Furthermore, the invention relates to a method for monitoring an operation of a machine with a prediction system that is generated based on a corresponding method. Still further, the invention relates to a use a Generalized Additive Model (GAM) for generating a prediction system and a machine installation that utilizes a prediction system that is generated based on a corresponding method.

### BACKGROUND

The article “Electrical Energy Prediction of Combined Cycle Power Plant Using Gradient Boosted Generalized Additive Model” by Nikhil Pachauri and Chang Wook Ahn, published on Feb. 22, 2022 in “IEEE Access”, discloses a predictive model for the electrical power produced by a combined cycle power plant which is based on a generalized additive model. The model utilizes an ambient temperature, an exhaust vacuum, a relative humidity, ambient pressure and electrical energy output as variables.

Furthermore, the article “Comprehensive and Comparative Analysis of GAM-Based PV Power Forecasting Models Using Multidimensional Tensor Product Splines Against Machine Learning Techniques”, published on Nov. 1, 2021 in “Energies”, teaches a method for predicting the power output of a PV system. The PV system is subjected to seasonally variable ambient conditions which affect its performance.

### SUMMARY

Prediction systems are being used in a variety of technical applications, especially in the field of turbomachinery. Turbo machines are subjected to changing ambient conditions which may impede their prediction precision. Also, the learning rate of several machine-learning algorithms, which form the basis for many prediction systems, is impeded by changing ambient conditions. Therefore, there is a need for a prediction system that yields exact predictions for the operation of a machine and that can be deployed quickly. Thus, it is an object of the present disclosure to provide a solution that offers an improvement in at least one of these aspects.

The objects described above is achieved by a method for generating a prediction system for a machine. The machine is subjected to cyclically variable ambient conditions which affect an operation of the machine. The prediction system is configured to predict at least one process variable of the machine. The method comprises that a set of training data is provided. The training data set comprises a plurality of ambient parameters of the machine, a plurality of performance parameters of the machine and values of the at least one process variable of the machine. Furthermore, the method comprises that the correlation value is determined between the at least one process variable and each of the plurality of the ambient parameters and each of the performance parameters of the machine for a first time interval.

The correlation value quantifies the intensity of a correlation between the at least one process variable and the corresponding performance parameter or the corresponding ambient parameter. Still further, the method comprises that at least one model relevant ambient parameter and at least one model relevant performance parameter are determined based on the corresponding correlation values. The at least one model relevant ambient parameter is one of the ambient parameters and the at least one model relevant performance parameter is one of the performance parameters. Furthermore, the method comprises that the at least one model relevant ambient parameter, the at least one model relevant performance parameter and the process variable are being fed into a model generating algorithm. The method also comprises that a first prediction model is generated based on the first time interval. The generated first prediction model is a part of the prediction system.

The object outlined above is also achieved by a computer program product that comprises a computer-readable program code that is embodied on a non-transitory storage medium. The computer-readable program code is configured to cause a computer to perform the following when it is loaded into a memory of a computer. The computer-readable program code is configured to receive a set of training data which comprises a plurality of ambient parameters of a machine, a plurality of performance parameters of the machine and at least one process variable of the machine. Furthermore, the computer-readable program code is configured to determine a correlation value between the at least one process variable and each of the plurality of ambient parameters of the machine and each of the performance parameters of the machine for a first time interval. A correlation value quantifies a correlation between the at least one process variable and the corresponding ambient parameter or the corresponding performance parameter respectively.

The method also comprises that at least one model relevant ambient parameter and at least one model relevant performance parameter are determined based on the corresponding correlation values. To that end, the present correlation values may be filtered according a criterion to determine the at least one model relevant ambient parameter among the ambient parameters and the at least one model relevant performance parameter respectively. Still further, the computer-readable program code is configured to feed the at least one model relevant ambient parameter and the at least one model relevant performance parameter into a model generating algorithm and to generate a first prediction model based on the first time interval through the model generating algorithm. Furthermore, the computer-readable program code is configured to output the first prediction model that based on the first time interval. The first prediction model is a part of the prediction model that is to be generated by the computer program product.

In addition to that, the object described above is also achieved by a use of a Generalized Additive Model, also referred to as a GAM, for generating a prediction system of a machine. The prediction system is configured to predict at least one process variable of the machine. The Generalized Additive Model, GAM, is utilized to generate several prediction models. Each of the prediction models is based on at least one ambient parameter of the machine and at least one performance parameter of the machine, which are both separately selected for different time intervals.

### BRIEF DESCRIPTION OF THE DRAWINGS

In the following, the present disclosure is described in more detail in several figures. The figures are to be construed as mutually complementary. Particularly, identical numerals are to be construed as having the same technical meaning. The features of the embodiments shown in the figures may be combined with each other. Additionally, the features of the embodiments shown in the figures my also be combined with the embodiments outlined above and below. In particular, the figures show:

FIG. 1 a schematic overview of a first embodiment of the disclosed method;

FIG. 2A a structure of used training data according to the first embodiment of the disclosed method;

FIG. 2B a structure of used training data according to a second embodiment of the disclosed method;

FIG. 2C a structure of used training data according to a third embodiment of the disclosed method;

FIG. 3 a schematic overview of an embodiment of the disclosed machine installation.

### DETAILED DESCRIPTION

The disclosed method is configured for generating a prediction system for a machine, the machine being subjected to cyclically variable ambient conditions. The ambient conditions may be caused by changing weather conditions on a daily basis or a seasonal basis. Such changes may be a temperature or humidity cycle between daytime and nighttime conditions or over the seasons. The prediction is configured to predict at least one process variable of the machine. The at least one process variable may be any quantity that is affected by how the machine is being operated. Among others, the at least one process variable may be a concentration of a component of an exhaust of the machine. The disclosed method comprises that a set of training data is provided which comprises a plurality of ambient parameters of the machine, a plurality of performance parameters of the machine and the least one process variable of the machine.

The training data may reflect a past operation of the machine or a past operation of a machine of the same type. Furthermore, the training data may be a time series for at least one of the ambient parameters, at least one of the performance parameters and the at least one process variable. Furthermore, the method comprises that a correlation value is determined between the at least one process variable and each of the plurality of ambient parameters and each of the plurality of performance parameters. The correlation value quantifies a correlation between the at least one process variable and the corresponding ambient parameter or the corresponding performance parameter respectively. A high correlation value indicates that there is an immediate connection, in some cases even an immediate causation, between the at least one process variable and the corresponding ambient parameter or performance parameter respectively. Accordingly, a low correlation value indicates that there is little or even no connection between the at least one process variable and the corresponding ambient parameter or the corresponding performance parameter. Such correlation values may be Pearson correlation coefficients, also known as a PCCs. The correlation value is determined for a first time interval, which is a portion of the time interval covered by the training data.

Still further, the disclosed method comprises that at least one model relevant ambient parameter is determined among the present ambient parameters. The disclosed method also comprises that at least one model relevant performance parameter is determined among the present performance parameters. Both the at least one model relevant ambient and the at least one model relevant performance parameter are determined based on their corresponding correlation values. The at least one model relevant ambient parameter and the at least one model relevant performance parameter may be determined by filtering the ambient parameters and the performance parameters according to a selectable criterion. For example, a minimum correlation value may be set to define which of the ambient parameters or performance parameters respectively is model relevant. Alternatively, at least one of the ambient parameters and the performance parameters may be sorted by the magnitude of their respective correlation values, the ones with the highest correlation values being categorized as model relevant.

The disclosed method further comprises that the at least one model relevant ambient parameter, the at least one model relevant performance parameter, and the at least one process variable are being fed into a model generating algorithm. In that step, the values of the at least one model relevant ambient parameter, the at least one model relevant performance parameter and the at least one process variable pertaining to the first time interval are being fed into the model generating algorithm. As for the model generating algorithm, the at least one model relevant ambient parameter, the at least one model relevant performance parameter and the at least one process variable serve as training data and constitute a portion of the training data originally provided. Based on that, a first prediction model is generated by the model generating algorithm. The first prediction model is a part of the prediction system that is to be generated based on the disclosed method.

The first prediction model is a model that is suitable to predict the at least one process variable for a future time interval that at least partially corresponds to the first time interval. The first prediction model may be configured to predict the at least one process variable of the machine in the future time. The future time interval may cyclically correspond to the first time interval. If the first time interval covers a specific month, the first prediction model may be configured to predict the process variable in the same month of any future year. Alternatively, if the first time interval covers a specific month, the future time interval may extend beyond that same month of any future year. The same applies accordingly to all conceivable time intervals accordingly. The first time interval is a time interval that will substantially repeat within the cycle in which the variable ambient conditions repeat. Without limitations, the first time interval may be a week, a fortnight or a month which occurs every year.

According to the disclosed method, the model generating algorithm that is utilized to generate the first prediction model is a Generalized Additive Model, also commonly referred to as a GAM. Among others, the disclosed method is based on the surprising finding that Generalized Additive Models are suitable to generate precise prediction models when they are based on limited portions of training data. With the training data being limited to the first time interval and to the identified at least one model relevant ambient parameter, the at least one model relevant performance parameter and the at least one process variable, the Generalized Additive Model is capable of processing these data quickly and still yield a precise first prediction model. Thus, the disclosed method allows for quickly providing a precise and reliable prediction system. The method may be a computer-implemented method, in which at least one of the aspects described above is performed using a computer.

A further embodiment of the disclosed method comprises that a correlation value is determined between the at least one process variable and each of the plurality of the ambient parameters and each of the performance parameters for a second time interval. Furthermore, at least one model relevant ambient parameter and at least one model relevant performance parameter are determined based on the corresponding correlation values. In that step, both the at least one model relevant ambient parameter and the at least one model relevant performance parameter are determined for the second time interval. Still further, the disclosed method comprises that the at least one model relevant ambient parameter, the at least one model relevant performance parameter and the at least one process variable are being fed into the model generating algorithm.

Based on that a second prediction model for the second time interval is generated by the model generating algorithm. Additionally, the first prediction model and the second prediction model are concatenated to form the prediction system. The first and second time intervals are non-identical time intervals which are not comprised in one another. The disclosed method allows for generating separate prediction models for different time intervals with are concatenated or merged to form a unitary prediction model. Corresponding to the first time interval, the second time interval is also a portion of the training data originally provided in the disclosed method. Among others, the disclosed method is based on the surprising finding that different ambient parameters and performance parameters are dominant for prediction models covering different time intervals. Generating separate prediction models for different time intervals allows for having a simple, yet well-adapted prediction system for different points in time. Altogether, the disclosed method allows for accelerating the generation of precise prediction systems. Correspondingly, a prediction models for a third, fourth, etc. time interval, which constitute a third, fourth, etc. prediction model, may be generated and concatenated with the first and second prediction models.

In yet another embodiment of the disclosed method, the first time interval and the second time interval are subsequent time intervals or partially overlapping time intervals. When the first and second time interval are subsequent time intervals, there may be a gap in between them. Thus, the prediction models generated for the first and second time interval are independent of each other. That allows for easily replacing one of the prediction models which are concatenated to form the prediction system. Consequently, the prediction systems generated based on the disclosed method suitable to be updated in a segmented manner. Even minor improvements in single prediction models may be deployed in such a prediction system without causing undue downtime.

In the disclosed method, at least one of the at least one model relevant ambient parameter and the at least one model relevant performance parameter may be determined based on a threshold for their corresponding correlation values. The threshold may be selected by a user, and algorithm or an artificial intelligence and distinguishes, which of the ambient parameters and the performance parameters is a reliable predictor for the process variable and to which extend. In turn, ambient parameters and performance parameters with little of no prediction strength may be ignored in the further course of the disclosed method. That reduces the amount of unnecessary computations for the model generating algorithm.

Alternatively, at least one of the at least one model relevant ambient parameter and the at least one model relevant performance parameter may be determined based on an order of the magnitudes of their corresponding correlation values. Sorting the ambient parameters and the performance parameters by the magnitudes of their associated correlation values allows for keeping the number of identified model relevant ambient parameters and model relevant performance parameters low. That, in turn, results in an accelerated generation of the corresponding prediction model. Additionally, prediction models with a reduced number of model relevant parameters are less susceptible to disturbances, for example temporarily inavailable sensors.

In another embodiment of the disclosed method, the at least one process variable is at least one of an emissions parameter, a yield of a chemical product, a yield of a chemical by-product and a measurement value of the machine. In particular, the emissions parameter may be an amount or a concentration of a component of an exhaust of the machine, especially a pollutant. Emissions parameters are considerably affected by changing ambient conditions, thus requiring a precise prediction system. The same applies to industrial-scale chemical processes. The measurement value may be a parameter that is generated during the operation of a measuring system. Such a measuring system may be a fluid or gas analytical product like a gas analyzer or a gas chromatograph. Gas analyzer are susceptible to changes in ambient temperature and yet are to precisely detect a composition of a gas sample. Altogether, the disclosed method may be utilized to generate prediction systems for a variety of machines and applications and allows for running their respective operations more cost-efficiently.

In addition to that, the at least one performance parameter is at least one of an ambient temperature, a relative ambient humidity and absolute ambient humidity and an ambient pressure. Each of these ambient parameters changes cyclically seasonally or daily and affects the operation of a variety of machines. Furthermore, each of them affects oxidizing processes like a combustion or many chemical reactions. Ambient parameters like ambient temperature, relative ambient humidity, absolute ambient humidity and ambient pressure show different correlation values at different time intervals. In many applications, they constitute highly relevant parameters, but not to the same extent all the time. If they are considered for a suitable amount of time, they may be deemed to have a constant relevance, which reflects in an accordingly high correlation value. Consequently, the above-mentioned ambient parameters are very suitable parameters for the disclosed method to generate a precise and reliable prediction model for a limited time interval. Furthermore, the at least one performance parameter may be one of a solar irradiation parameter and a vibration parameter.

In another embodiment of the disclosed method, the machine may be one of a turbo machine, a combustor, an incinerator, a chemical process installation and a measuring system, for example a fluid of gas analytical product. Particularly, the turbo machine may be a gas turbine or a steam turbine, more particularly a power plant turbine, or turbine of a ship drive. The chemical process installation may be a column of a refinery or a chemical reactor. The measuring system may be embodied as a fluid or gas analyzer, particularly a continuous gas analyzer, or a gas chromatograph. Each of these machines is susceptible to changes of its ambient parameters, thus requiring a reliable prediction system to plan its operation. Taking into account the scale of such machines, even minor improvements result in significant cost reductions for their operation.

In yet another embodiment of the disclosed method, the at least one performance parameter may be at least one of an output power, a gas turbine exhaust pressure, a compressor discharge pressure, an air filter difference pressure, a difference between a turbine inlet temperature and a turbine exit temperature, a fuel amount, an air-to-fuel ratio, a flame temperature and an electromagnetic spectrum of a flame. Each of these performance parameters alone or in combination with each other characterizes the operational state of the machine. In a variety of cases, at least one of these performance parameters shows a high correlation to the at least one process variable. Furthermore, at these performance parameters allow for categorizing the regime under which the machine is operated, e.g. if it is running under full load or partial load. Still further, these performance parameters may easily be influenced by an operator or a control unit of the machine. Based on the prediction system, the operation of the machine may easily be adapted to assume an improved operational state.

In the disclosed method, the first prediction model may be configured to predict the at least one process variable by extrapolating the at least one process variable beyond states of the machine given by the at least one of the model relevant ambient parameter and the at least one model relevant performance parameter. The disclosed method is also based on the surprising finding that even with limited training data, prediction model for at least one of the first time interval, i.e. the first prediction model, may be extrapolated without significant loss of precision. Therefore, the disclosed method may be utilized to generate a prediction system before a complete set of training data is collected, which covers the whole cycle during which the ambient conditions of the machine vary.

Based on the disclosed method, the model generating algorithm is capable of generating prediction systems which allow for such extrapolating without impairing the precision of the underlying first prediction model or prediction models. Compared to the disclosed method, different model generating algorithms like linear regression, polynomial regression, XGBoost or neural networks show an inferior precision when a process variable is determined by extrapolating beyond know states of the machine. Correspondingly, the above-mentioned aspects may also apply to the second prediction model or for a third, fourth, etc. prediction model.

In addition to that, the first prediction model may be configured to predict the at least one process variable by interpolating the at least one process variable between states of the machine given by the at least one model relevant ambient parameter and the at least one performance parameter. Among others, the disclosed method is based on the surprising finding that its generated prediction models still offer considerable precision when they are subjected to interpolation. Other known model generating algorithms like linear regression, XGBoost or neural networks generate prediction models which significantly deviate from reality for operational states in between known states. Consequently, the prediction system generated based on the disclosed method is more reliable. and may be generated on a relatively small set of training data.

The object outlined above is also achieved based on a prediction system for a machine. The disclosed prediction system is at least partially generated through a method according to one of the embodiments described above. The benefits described in context with the disclosed method also apply to the disclosed prediction system.

Moreover, the object described above is also achieved by a computer program product that comprises computer-readable program code which is embodied on a non-transitory storage medium. The program code is configured to cause a computer to perform the following when loaded into a memory of the computer. The program code, and thus the computer program product, is configured to perform the method according to at least one of the embodiments outlined above. The features and benefits of the disclosed method and the disclosed prediction system also apply to the disclosed computer program product accordingly.

Additionally, the object outlined above is also achieved by a method for monitoring an operation of a machine that is connected to a plurality of sensors for measuring at least one performance parameter of the machine and an ambient parameter of the machine. The method comprises a step in which a prediction time interval for an intended operation of the machine is selected. Furthermore, at least one performance parameter of the machine is selected. The prediction time interval and the at least one performance parameter may be selected by at least one of a user, an artificial intelligence, and a control unit of the machine. The prediction time interval defines a future interval for which a prediction of at least one process parameter is to be made.

The selected performance parameter is configured to influence the intended operation of the machine. In a further step, at least one predicted process parameter of the machine is determined. The at least one predicted process parameter is determined for the prediction time interval based on a prediction system for the prediction time interval. The prediction system is configured to process at least the performance parameter as an input to determine the predicted process parameter. In another step of the disclosed method, the machine is being run and the process parameter is measured while the machine is being run. To that end, the sensors of the machine are being utilized. The measured process parameter is compared to the at least one predicted process parameter. The predicted process parameter and the measured process parameter relate to the same physical quantity.

In a further step, an abnormal state of the machine is detected when a difference between the predicted process parameter and the measured process parameter exceeds a selectable threshold. The threshold may be selected by at least one of the user, an artificial intelligence, and the control unit of the machine. By selecting the threshold, the sensitivity of the disclosed method for monitoring the machine may be adjusted. The disclosed method for monitoring utilizes a prediction model that is generated through a method for generating a prediction system according to at least one of the embodiments described above. Such prediction models offer an enhanced prediction precision and allow for detecting abnormal states of the machine reliably. Furthermore, such models may be deployed quickly and require a reduced amount of training data.

The features and benefits of the method for generating a prediction system, a corresponding prediction system, and a corresponding computer program product also apply to the disclosed method for monitoring the operation of a machine. In another embodiment of the disclosed method for monitoring the operation of a machine, at least one performance parameter of the machine may be altered when an abnormal state of the machine is detected. By altering at least one performance parameter, the machine may be switched to a different mode of operation. Such a different mode of operation may be a safer mode of operation to avoid excessive wear of the machine. To that end, the prediction system may be configured to communicate with a control unit of the machine. In yet another embodiment of the disclosed method, the abnormal state may be caused by a failed sensor. The failed sensor may be determined and deactivated. Furthermore, the disclosed method may comprise that the prediction system is utilized to assume the function of the failed sensor at least temporarily.

Moreover, the object described above is also achieved by a machine installation that comprises a machine that is connected to a self-learning monitoring unit. The self-learning monitoring unit comprises a prediction system for predicting at least one process variable of the machine. In the disclosed machine installation, the prediction system is being generated through a method for generating a prediction system according to one of the embodiments disclosed above. In another embodiment of the claimed machine installation, the prediction system may be configured to perform at least one embodiment of the disclosed method for monitoring the operation of a machine to monitor the operation of the machine in the machine installation. Consequently, the features and benefits of the disclosed method for generating a prediction system, the corresponding prediction system, the corresponding computer program product, and the corresponding method for monitoring the operation of a machine also apply to the disclosed machine installation.

Moreover, the object described above is also achieved by a self-learning monitoring unit for a machine that comprises a memory and a processor which are configured to run a computer program product. The self-learning monitoring unit is configured to receive training data from at least one of a plurality of sensors connected to the machine. The self-learning monitoring unit is also configured to receive training data from an identical different machine. Such an identical different machine may be a machine of the same type as the machine to which the self-learning monitoring unit is to be connected.

The self-learning monitoring machine is configured to run a computer program product that is configured to perform the following steps:

A set of training data is received, the set of training comprising a plurality of ambient parameters related to the machine, a plurality of performance parameters related to the machine and at least one process variable related to the machine. The ambient parameters and the performance parameters may be measured at the machine to which the self-learning monitoring unit is to be connected to at least one of the machine and an identical different machine. Such an identical different machine may be a machine of the same type. Furthermore, a correlation value between the at least one process variable and each of the ambient parameters and each of the performance parameters related to the machine for a first time interval is determined. Based on that, at least one model relevant ambient parameter and at least one model relevant parameter is determined based on the correlation values. When the at least one model relevant ambient parameter and the at least one model relevant performance parameter is determined, they and the process variable are fed into a model generating algorithm. With that as input, the model generating algorithm is utilized to generate a first prediction model based on the first time interval. Such a first prediction model may be a part of a prediction system.

The disclosed self-learning monitoring unit may be configured to perform at least one of the embodiments of the disclosed method for generating a prediction system which are outlined above. Thus, the features and benefits of the disclosed method for generating a prediction system also apply to the disclosed self-learning monitoring unit. Accordingly, the features and benefits of the disclosed prediction system, the disclosed computer program product, the disclosed method for monitoring the operation of a machine, and the discloses machine installation also apply to the disclosed self-learning monitoring unit.

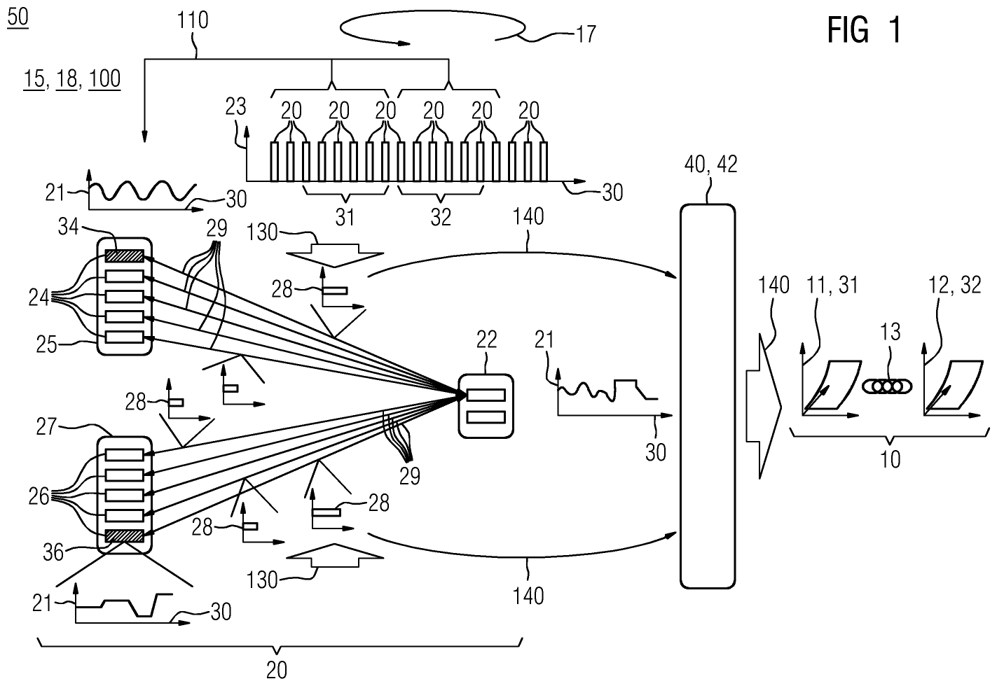

FIG. 1 shows a schematic overview of a first embodiment of the disclosed method 100 which is configured to generate a prediction system 10 that is suitable to predict the operation of a machine 15. The machine 15 is a turbo machine 18 and is subjected to ambient conditions that change cyclically. That reflects in several ambient parameters 24 which are each part of an ambient parameter data set 25. The ambient parameter data set 25 with its ambient parameters 24 is part of a set of training data 23, which comprises multiple training data 20. The training data 20 describe the ambient conditions of the machine 15 at different points in time. That is symbolized by the time scale 30 in the diagram in the top portion of FIG. 1. The cyclical nature 17 of the ambient conditions is symbolized by the annular arrow 17. The training data 20 also comprise multiple performance parameters 26 which form a performance parameter set 27. Both the ambient parameters 24 and the performance parameters 26 form time series 21, as indicated by the respective time scales 30. The ambient parameters 24 encompass an ambient temperature, an ambient pressure, a relative ambient humidity and an absolute ambient humidity. The performance parameters 26 comprise an output power, a gas turbine exhaust pressure, a compressor discharge pressure, an air filter difference pressure and a difference between a turbine inlet temperature and a turbine exit temperature. In addition to that, the training data 20 also comprises at least one process variable 22 which also forms a time series 21. The process variable 22 is a concentration of a component of the exhaust from the machine 15.

In a first step 110 of the disclosed method 100, the training data set 23 is provided for further evaluation. In a subsequent second step 120, training data 20 from a first time interval 31 is extracted from the training data set 23. The first time interval 31 is a portion of the time covered by the training data set 23. Furthermore, a correlation value 28 is determined for each ambient parameter 24 in combination with the at least one process variable 22. The correlation value 28 quantifies the strength of a correlation 28 between the process variable 22 and the respective ambient parameter 24. Correspondingly, a correlation value 28 is determined between each performance parameter 26 and the at least one process variable 22. Accordingly, the correlation value 29 quantifies the strength of a correlation 29 between the at least one process variable 22 and the respective performance parameter 26. The higher the correlation value 28 of an ambient parameter 24 or a performance parameter 26, the more likely it is that it is model relevant for the prediction system 10 that is to be generated.

The disclosed method 100 also comprises a third step 130 in which each of the correlation values 28 are evaluated. In FIG. 1 the correlation values 28 are sorted by their magnitude, thus determining the ambient parameter 24 with the highest correlation value 28 and the performance parameter 26 with the highest correlation value 28. These are determined to be a model relevant ambient parameter 34 and a model relevant performance parameter 36. In further embodiments of the disclosed method 100, model relevant parameters may be determined by a different criterion. In a subsequent fourth step 140, the model relevant ambient parameter 24, the model relevant performance parameter 36 and the at least one process variable 22 are being fed into a model generating algorithm 40. The model generating algorithm 40 is a Generalized Additive Model 42, also referred to as a GAM.

In the fourth step 140, only the values of the model relevant ambient parameter, the model relevant performance parameter and the process variable pertinent to the first time interval 31 are being fed into the model generating algorithm 40. Based on that as an input, the model generating algorithm 40 generates a first prediction model 11 that covers at least the first time interval 31. Since the first time interval 31 occurs cyclically, the corresponding prediction model 12 is configured to predict the at least one process variable 22 every time the first time interval 31 repeats. The first prediction model 11 is also configured to predict the at least one process variable 12 under an operating regime that is different from the operation reflected in the performance parameters 26 of the training data 20 for the first time interval 31. The first time interval 31 may be a week, a fortnight or a month during which the machine 15 is operated.

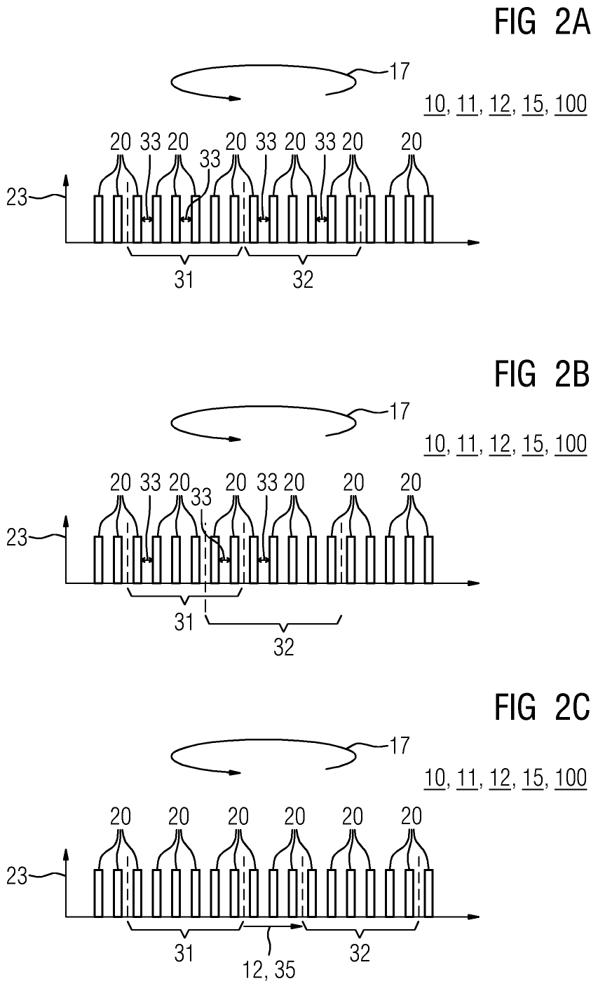

In the embodiment of the disclosed method 100 according to FIG. 2, at least the second, third and fourth step 120, 130, 140 are repeated for a second time interval 32. The second time interval 32 substantially immediately follows the first time interval 31 and covers a portion of the time covered by the training data set 23. Thus, based on training data 20 pertinent to the second time interval 32, a second prediction model 12 is generated by the model generating algorithm 40 that covers at least the second time interval 32. The second time interval 32 is also cyclical. Correspondingly, the second prediction model 12 for the second time interval 32 is configured to predict the at least one process variable 22 every time the second time interval 32 repeats, even under an operating regime different from the performance parameters 26 in the training data 20 for the second time interval 32. Both prediction models 11, 12 are being output in the fourth step 140 to be further processed in a subsequent step. In that subsequent step, the prediction models 11, 12 for the first and second time interval 31, 32 are being concatenated. With the concatenation 13 between the prediction models 11, 12, a unitary prediction system 10 is formed.

FIG. 2A shows a more detailed structure of training data 20 in a training data set 23 that is used in the first embodiment of the disclosed method 100. The training data set 23 comprises training data 20 for multiple subsequent points in time, each capturing a known state of the machine 15. The training data set 23 covers at least a portion of a cycle 17 during which the ambient conditions of the machine 15 change. The training data 20 are recorded substantially at a constant rate. A first prediction model 11 generated based on training data 20 from the first time interval 31 also allows for predicting the at least one process variable 22 by interpolating, thus also covering inactive intervals 33 between the training data 20. The same correspondingly applies to a second prediction model 12 generated based on training data 20 from the second time interval 32. The second time interval 32 is substantially as long as the first time interval 31. Generating a prediction system 10 by generating prediction models 11, 12 for substantially immediately subsequent time intervals 31, 32 allows for accelerating the disclosed method 100.

The structure of training data 20 used in a second embodiment of the disclosed method 100 is shown in FIG. 2B. Corresponding to FIG. 2A, the training data set 23 comprises training data 20 recorded at different points in time. A first prediction model 11 generated based on training data 20 from the first time interval 31 allows for interpolating between its training data 20 when the underlying cycle 17 repeats. The same correspondingly applies to a second prediction model 12 generated based on training data 20 from the second time interval 32. The first and second time interval 31, 32 partially overlap.

The structure of training data 20 used in a third embodiment of the disclosed method 100 is shown in FIG. 2C. The training data set 23 has the same structure as the training data sets 23 in FIG. 2A and FIG. 2B. In the third embodiment shown in FIG. 2C, the first and second time interval 31, 32 are disjoint, having unused training data 20 in between them. A first prediction model 11 derived from training data 20 from the first time interval 31 is capable of extrapolating beyond the states reflected in the training data 20 the first time interval 31 comprises. Correspondingly, a second prediction model 12 is generated. Since prediction models 11, 12 generated based on training data 20 from limited time intervals 31, 32 still offer precise predictions under extrapolation 35, gaps between the first and second time interval 31, 32 may still be covered by the respective prediction models 11, 12. With disjoint time intervals 31, 32, the amount of training data 20 to be processed may be reduced significantly. Consequently, the disclosed method 100 only requires a reduced amount of computing power and may be implemented on existing machines 15 as a retrofit measure.

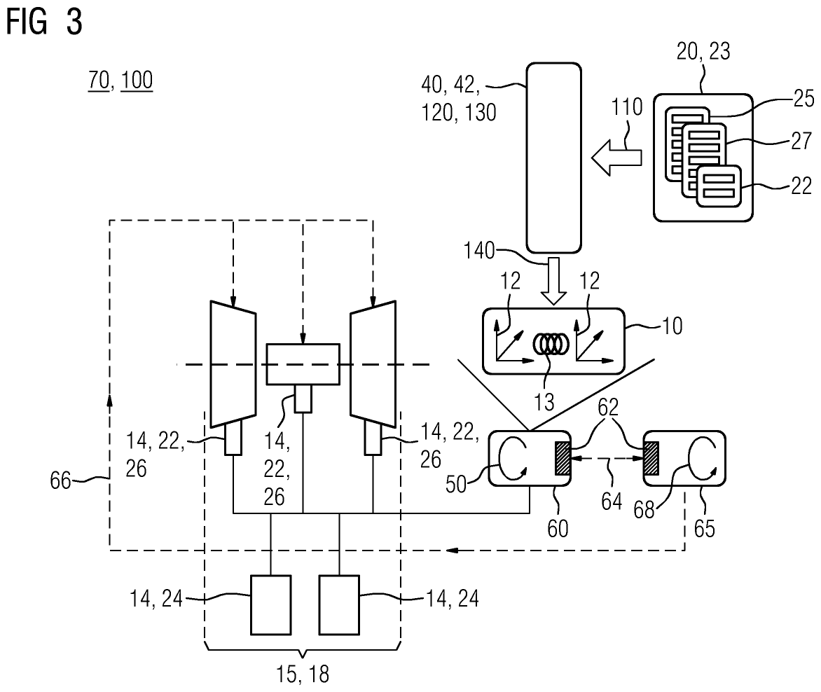

FIG. 3 shows a schematic overview of an embodiment of the disclosed machine installation 70. The machine installation 70 comprises a machine 15 that is a turbo machine 18. The machine 15 comprises a plurality of sensors 14 which are configured to measure at least one performance parameter 26 and at least one process parameter 22 of the machine 15. The machine 15 is also connected to a plurality of sensors 14 which are configured to measure at least one ambient parameter 24 of the machine 15. The sensor 14 are connected to an evaluation unit 60 that comprises a non-transitory memory and which is configured to run a computer program product 50. The sensors 14 are connected to the evaluation unit 60 to record values for the at least one ambient parameter 24, the at least one performance parameter 26 and the at least one process variable 22 and to store them as training data 20 into a training data set 23. The at least one ambient parameter and the at least one performance parameter 26 each form a time series 21, thus forming an ambient parameter set 25 and a performance parameter set 27 respectively.

Therefore, the disclosed machine installation 70 is configured to generate a training data set 20 which may be used to perform the disclosed method 100. The training data set 20 is provided in a first step 110 and processed in a subsequent second, third and fourth step 120, 130, 140. The training data set 20 is processed by a model generating algorithm 40 that is embodied as a Generalized Additive Model 42, also referred to as a GAM. The model generating algorithm 40 is utilized to generate prediction models 12 which are combined by concatenation 13 to form a prediction system 10. The disclosed method 100 is performed through a computer program product 50 which is run on the evaluation unit 60. The evaluation unit 50 comprises a data interface 62 which allows for a communication 62 with a data interface 62 of a control unit 65 of the machine 15. The control unit 65 comprises a control program 68 and is configured to send control signals 66 to the machine 15. At least one of the evaluation unit 60 and the control unit 65 are configured to run the prediction model 10 generated by the model generating algorithm 40 to schedule a operation of the machine 15 and to implement that schedule.

1. A method for generating a prediction system for a machine, the machine being subjected to cyclically variable ambient conditions, the prediction system being configured to predict at least one process variable of the machine, comprising:
Providing a set of training data comprising a plurality of ambient parameters of the machine, a plurality of performance parameters of the machine, and at least one process variable of the machine;
Determining a correlation value between the at least one process variable and each of the plurality of ambient parameters and each of the performance parameters of the machine for a first time interval;
Determining at least one model relevant ambient parameter and at least one model relevant performance parameter based on the corresponding correlation values;
Feeding the at least one model relevant ambient parameter, the at least one model relevant performance parameter, and the process variable into a model generating algorithm and generating a first prediction model based on the first time interval, the first prediction model being a part of the prediction system;
wherein the model generating algorithm is a Generalized Additive Model (GAM).

2. The method for generating a prediction system for a machine according to claim 1, comprising:
Determining a correlation value between the at least one process variable and each of the plurality of the ambient parameters and each of the performance parameters of the machine for a second time interval;
Determining at least one model relevant ambient parameter and at least one model relevant based on the corresponding correlation values;
Feeding the at least one model relevant ambient parameter, the at least one model relevant performance parameter and the process variable into a model generating algorithm and generating a second prediction model based on the second time interval;
Concatenating the first prediction model and the second prediction model to form the prediction system.

3. The method for generating a prediction system for a machine according to claim 2, wherein the first time interval and the second time interval are subsequent time intervals or partially overlapping time intervals.

4. The method for generating a prediction system for a machine according to claim 1, wherein at least one of the at least one model relevant ambient parameter and the at least one model relevant performance parameter are determined based on a threshold for their corresponding correlation value or by an order based on the magnitudes of their corresponding correlation values.

5. The method for generating a prediction system for a machine according to claim 1, wherein the at least one process variable is at least one of an emissions parameter, a yield of a chemical product, a yield of a chemical by-product and a measurement sensitivity parameter of the machine.

6. The method for generating a prediction system for a machine according to claim 1, wherein the at least one performance parameter is at least one of an ambient temperature, a relative ambient humidity, an absolute ambient humidity, and an ambient pressure.

7. The method for generating a prediction system for a machine according to claim 1, wherein the machine is one of a turbo machine, a combustor, an incinerator, a chemical process installation.

8. The method for generating a prediction system for a machine according to claim 1, wherein the at least one performance parameter is at least one of an output power, a gas turbine exhaust pressure, a compressor discharge pressure, a fuel amount, an air-to-fuel ratio, a flame temperature and an electromagnetic spectrum of a flame.

9. The method for generating a prediction system for a machine according to claim 1, wherein the prediction model for the first time interval is configured to predict the at least one process variable by extrapolating the at least one process variable beyond states of the machine given by the at least one the model relevant ambient parameter and the at least one model relevant performance parameter.

10. The method for generating a prediction system for a machine according to claim 1, wherein the prediction model for the first time interval is configured to predict the at least one process variable by interpolating the at least one process variable between states of the machine given by the at least one model relevant ambient parameter and the at least one performance parameter.

11. The prediction system for monitoring at least one process variable of a machine, wherein the prediction system is at least partially generated through a method according to claim 1.

12. A computer program product comprising a computer-readable program code embodied on a non-transitory storage medium, which when loaded into a memory of a computer, causes the computer to perform a method for generating a prediction system for a machine according to claim 1.

13. A method for monitoring an operation of a machine that is connected to a plurality of sensors for measuring at least one performance parameter of the machine and an ambient parameter of the machine, comprising:
Selecting a prediction time interval for the intended operation of the machine and selecting at least one performance parameter of the machine;
Determining at least one predicted process parameter of the machine for the prediction time interval based on a prediction system;
Running the machine, measuring the process parameter and comparing the measured process parameter to the at least one predicted process parameter;
Detecting an abnormal state of the machine when a difference between the measured process parameter and the predicted process parameter exceeds a selectable threshold;
wherein the prediction system is generated through a method according to claim 1.

14. The method for monitoring an operation of a machine according to claim 13, the method comprising:
Identifying a failed sensor that is pertinent to the detected abnormal state of the machine;
Deactivating the failed sensor and substituting the failed sensor with the prediction system.

15. The method for monitoring an operation of a machine according to claim 13, the method comprising:
Identifying a performance parameter pertinent to the detected abnormal state of the machine:
Altering the identified performance parameter and switching the machine to a different mode of operation.

16. A machine installation, comprising a machine connected to a self-learning monitoring unit, the self-learning monitoring comprising a prediction model for predicting at least one process variable of the machine, the prediction model being generated through a method according to claim 1.

17. A self-learning monitoring unit for a machine, comprising a memory and a processor which are configured to run a computer program product, the self-learning monitoring unit being configured to receive training data from at least one of a plurality of sensors connected to the machine and training data from an identical different machine, the self-learning unit being configured to run a computer program product that is configured to perform the following:
Receiving a set of training data comprising a plurality of ambient parameters related to the machine, a plurality of performance parameters related to the machine and at least one process variable related to the machine;
Determining a correlation value between the at least one process variable and each of the ambient parameters and each of the performance parameters related to the machine for a first time interval;
Determining at least one model relevant ambient parameter and at least one model relevant based on the corresponding correlation values;
Feeding the at least one model relevant ambient parameter, the at least one model relevant performance parameter and the process variable into a model generating algorithm and generating a first prediction model based on the first time interval;
Outputting the first prediction model.

18. A machine installation, comprising a machine connected to a self-learning monitoring unit, the self-learning monitoring comprising a prediction model for predicting at least one process variable of the machine, the prediction model being generated through a method according to claim 1.
